(19) United States
(12) Patent Application Publication
(10) Pub. No.: US 2008/0056959 A1
(43) Pub. Date: Mar. 6, 2008

(54) Scent sampling devices and related methods

(76) Inventor: Lee Cuthbert, San Francsico, CA (US)

Correspondence Address: DERGOSITS & NOAH LLP, FOUR EMBARCADERO CENTER, SUITE 1450, SAN FRANCISCO, CA, 94111, US

(21) Appl. No.: 11/823,003

(22) Filed: Jun. 25, 2007

Related U.S. Application Data
(60) Provisional application No. 60/824,273, filed on Aug. 31, 2006.
(60) Provisional application No. 60/824,273, filed on Aug. 31, 2006.
(60) Provisional application No. 60/824,274, filed on Aug. 31, 2006.
(60) Provisional application No. 60/825,188, filed on Sep. 11, 2006.

(51) Int. Cl. B32B 27/04; A47F 3/02

(52) U.S. Cl. 422/123; 221/27

(57) ABSTRACT

A fragrance sampling device having an inner wall of at least one layer that defines an air cavity and is made of a material capable of retaining a fragrance carrier, and an outer wall of at least one layer made of a material that is substantially impervious to the fragrance carrier. Air containing molecules of fragrance that evaporate from at least one layer of the inner wall is released through at least one opening in the inner and outer walls to the outside of the device when pressure is applied to the device.

### PRIOR APPLICATIONS

This application claims the benefit of U.S. Provisional Application No. 60/824,267, filed on Aug. 31, 2006; U.S. Provisional Application No. 60/824,273, filed on Aug. 31, 2006; U.S. Provisional Application No. 60/824,274, filed on Aug. 31, 2006; and U.S. Provisional Application No. 60/825,188, filed on Sep. 11, 2006, which are incorporated herein by reference.

### TECHNICAL FIELD

This invention relates to scent sampling devices that can be manufactured without a separate scent emitting wick. The sampling devices are preferably air-based and can be made in a variety of shapes. The sampling devices are designed for distribution by hand, through vending machines or by mail. The sampling devices can be carried, for example by a sales representative, and they can be affixed permanently or temporarily to point-of-sale displays and store fixtures, for example, a shelf, a table, a counter, a cabinet, a wall, a door, a display case, a window or a cash wrap station at check-out.

### BACKGROUND OF THE INVENTION

Currently retailers and consumer product manufacturers use product sampling as a means to get consumers to try their products. Research has shown that shoppers are more likely to purchase a product once they have sampled it. Consumer product manufacturers including fragrance companies, use in-store sampling organizations or in-house representatives called fragrance models or demonstrators for this purpose. This in-store sampling is an extremely expensive way to market a product because it involves hiring a person to stand in a store sometimes for eight hours a day. This person can only usually sample 500 shoppers a day at most. There is also the cost of getting the product to the stores to be sampled as well as the cost of the product itself.

Fragrance manufacturers face an additional set of challenges in their quest to get shoppers to try their fragrances. Many consumers are very sensitive to having an unknown scent sprayed on them by fragrance models because they do not know if they will like the fragrance. Even a small amount of perfume, eau de toilette or cologne can be detected for as long as five hours after it has been sprayed on someone. Spraying the scent in the air for a consumer to sniff causes problems as well as the air in the retail area soon becomes very heavily fragranced. This minimizes the ability of the fragrance model to demonstrate or the shopper to try more than one fragrance at a time in a certain area of the store.

Perfumes are difficult to demonstrate quickly to a shopper because of the heavy scent influence of the alcohol diluent that most perfumes carry as a conveyance agent. Fragrance demonstrators as a matter of course encourage shoppers to let the fragrance “dry down” for five to ten minutes after they spray it to get a better idea of a fragrance's nature. If a shopper tries to sample more than five or six different fragrances at one time, her/his sense of smell becomes temporarily dulled because of the influence of the alcohol diluent on the human olfactory system.

To reduce fragrance demonstrator costs, most retailers who sell fragrance will designate a “tester bottle” of each fragrance that they wish to feature. Shoppers are allowed to spray the fragrance on themselves, in the air or on tester blotter papers displayed nearby. This method can cause a number or problems for a retailer. Shoppers litter the store shelves, display counter and the retail floor with used blotter papers soaked in fragrance. The easy access of fragrance tester bottles also makes shoppers feel it is their right to open a new bottle of fragrance to test it if one hasn't been designated as a tester. And if blotter papers are not available, shoppers think nothing of spraying anything handy, including packages of nearby products causing a mess at the shelf. This fragrance oil residue can also migrate to floors making frequent floor cleaning and mopping a necessity.

This unauthorized use or opening of products at retail is not confined to the fragrance industry. Consumers at grocery, drug, and mass merchandiser stores frequently open bottles of shampoo, packages of soap and sticks of deodorant to get a whiff of the product inside. Consumer packaged goods manufacturers have tried blow-on microencapsulated fragrance labels which allow a shopper to “scratch n' sniff” a sample of the product's scent or fragrance. Once one shopper has scratched this label, it can lose a significant amount of its potency delivering a sub-optimal experience for the next shopper who picks up that package.

It has become common practice to distribute fragrance samples to potential customers by inserting scent strips in magazines or mailings. The scent strip process involves microencapsulating a fragrance and adhering it with glue to a printed magazine or mailing insert. The fragrance is released when the microcapsules are burst. This is usually accomplished by separating two sheets containing the microcapsules that have been temporarily adhered to one another. These burst microcapsules emit a scent because they are exposed to the air. This limits the reuse of this system as a sampling vehicle because the fragrance material cannot be easily protected from evaporation. Fragrance material is very volatile and evaporates quickly.

U.S. Pat. Nos. 5,188,236 (Sayers, et al.), 5,391,420 (Bootman, et al.), 4,889,755 (Charbonneau), and 4,817,860 (Shapiro) all disclose releasing fragrance samples through bursting microcapsules adhered to a substrate paper or cardboard backing. U.S. Pat. No. 5,419,958 (Charbonneau) discloses a process for preventing unwanted escape of fragrance material prior to fracturing of the microcapsules. However, in all of this prior art, the problem of quick evaporation of the fragrance material once the microcapsules are burst still exists.

This problem also exists with U.S. Pat. No. 6,123,221 (Simpson) which discloses a process to deliver folded scented coupons in a dispenser. These coupons contain microcapsules that fracture as the coupons are removed form the dispenser. Once the coupons have been activated in this manner, the scent quickly evaporates. U.S. Pat. Nos. 6,102,250 (Leo, Sr.) and 6,637,620 (Oshinsky, et al.) both disclose devices for dispensing cards that have been impregnated with a scent. Similarly, once these cards are exposed to the air, they start to lose their scent quickly through evaporation.

It has become standard practice in the cosmetics industry to mail or otherwise distribute liquid samples of fragrance to potential customers. Retail sales associates many times do not use them for their intended purpose of sampling to a shopper who is not familiar with the fragrance. Rather, they toss two or three at a time into shopping bags of consumers who have already bought that particular fragrance for their use when they travel. These glass vials are difficult to open and expensive to produce and can only be used to demonstrate to a single potential new user.

Frequently such samples are distributed in the form of “vial-on-cards”, which usually comprise a glass or plastic vial fastened to a cardboard backing. Another known means for packaging a unit dosage cosmetic sample or fragrance is the soft gelatin capsule. Similar in function to plastic or glass vials, these “soft gel” capsules contain a fluid sample of the fragrance.

These types of fragrance samples are awkward to use because they are so small. The fragrance must be applied directly to the skin to experience its intended scent, otherwise it is too concentrated. Once a fragrance is applied to the skin it begins to evaporate and can wear off in a matter of hours. U.S. Pat. No. 5,535,885 (Daniel, et al.) discloses a means to produce a unit-dose container that can survive the rigors of shipment through the mail or inclusion in printed material but it still does not solve the inherent problem of difficulty of use and reduction of evaporation once the fragrance has been released from the container.

U.S. Pat. No. 6,736,335 (Cuthbert) discloses a substantially flat envelope-shaped packet with a scent emitting material contained therein that is separate from the packet and not defined by any boundary of the cavity.

Devices that do not expose volatile fragrance oils of burst microcapsules directly to the surrounding air can diminish the rate of scent evaporation. This is accomplished by enclosing scented elements in a sack or “sachet”. The purpose of these sacks is to slowly deliver a pleasant scent to an area, usually to mask an unpleasant odor. U.S. Pat. Nos. 5,503,332 (Glenn), 4,306,892 (Atalie, et al.), and 4,854,501 (Ricci) all disclose fragrance holders for scenting the surrounding area by permeation of scents in the air. These sacks are not effective promotion vehicles for delivering scent samples because they deliver scent to a wide area, thereby causing the scent to linger for an extended period of time.

When one specific scent lingers in the surrounding air it can diminish a consumer's ability to experience any other scent. This creates a problem in a retail environment where a variety of fragrances or scented products are sold or in any other environment where it is desirable to experience more than one scent, fragrance or aroma. U.S. Pat. Nos. 6,450,419 (Martens, III, et al.) and 6,969,008 (Helf, et al.) disclose fragrance dispersion systems that deliver atomized liquids into the air through piezoelectric means either with an actuator or an orifice plate. U.S. Pat. Nos. 3,967,880 (Johnson), 6,136,277 (Nardini), 6,569,387 (Furner, et al.), and 6,669,092 (Leanheart, et al.) all disclose fragrance dispersion apparatus that emit a scent or fragrance into the surrounding air either through diffusion or liquid spray. All of these devices cause a scent to linger in the air for an extended period of time.

Accordingly, it is an object of the present invention to provide a scent sampling device that may be made in a variety of shapes and sizes without the need for a scent emitting wick material.

It is a further object of the present invention to provide a scent sampling device that does not require emission of a solid or liquid carrying the scent in order for the user to experience the scent.

It is a further object of the present invention to provide a scent sampling device that may be incorporated into a portable or fixed point-of-sale display or sampling mechanism that enables the user to experience a scent but precludes removal of the device from the display or mechanism.

It is yet a further object of the present invention to provide a cost-effective scent sampling device that eliminates the need for opening retail fragrance tester bottles that require the user to spray, atomize or otherwise experience the scent of the sample product

Further objects and advantages of my invention will become apparent from a consideration of the drawings and detailed description of the invention as provided below.

### SUMMARY OF THE INVENTION

The present invention relates to fragrance carrier devices and point-of-sale displays that incorporate those devices. Devices of the current invention deliver an air-based sample of a fragrance so a human may sample the smell of the fragrance.

A container of a fragrance sampling device of the current invention, according to certain embodiments, comprises a single wall having an inner and outer surface. In other embodiments, the device is comprised of an inner wall and an outer wall with each wall made of at least one layer. The device also includes an air cavity in its interior. The sampling device of the present invention has at least one opening for loading and/or for releasing a fragrance for sampling. The fragrance may be loaded with a carrier that is retained by an inner surface of the container wall or inner layer of the inner wall. Air containing molecules of fragrance that evaporate therefrom into the air cavity are released through an opening to the outside of the container when pressure is applied to the container. The container is comprised of materials that are flexible and provide spring back resilence to enable the container to return to its original shape after pressure is applied, e.g. by a person's hand or thumb, and air containing molecules of fragrance is released. In some embodiments, air from outside the contain may enter the container once pressure applied to the container ceases and the container returns to its original shape. The materials are selected to allow for retention of the fragrance carrier on the inner surface of the container wall or inner layer of the inner wall while preventing penetration of the fragrance carrier through the outer surface of the container wall or outer layer of the outer wall. The materials should be impervious to air to prevent unintended leakage of scent.

Containers may be made in a wide variety of shapes, thereby allowing for numerous sample packaging options. The scent may be introduced into the scent sampling device during the device manufacture or thereafter by spray or injection. The fragrance sampling device may also be tethered to a point-of sale display to allow sampling but preclude removal of the sampling container from the display.

Materials that can be used in the formation of the container include, but are not limited to: foil, laminates and plastics including styrene, polypropylene, polyethylene, PETG, rubber, and polyvinyl chloride. The container shapes include, but are not limited to, round, rectangular, or oval shaped bottles with flexible sides, spray bottles, inhaler bottles squeezable bulbs, blister packages and clamshell packages that can be closed around a scent emitting packaging material. The processes used to create this packaging include, but are not limited to: blister package manufacturing, thermoforming, vacuum forming, heat sealing, radio frequency sealing, extrusion, injection molding, and blow molding.

In some embodiments of the present invention, the sampling container may be in the form of a pump spray bottle, a spray bottle or a squeezable bottle. In other embodiments, a container of a sampling device of the invention has the shape of an envelope, a flat packet, a blister package, or a clamshell package.

The use of an air-based scent sampling device that comes in a wide variety of shapes and that does not require a separate scent emitting wick, reduces manufacture costs and enables consumers to experience the scent of a product without the aforementioned issues of tester bottles and emission of solids and/or liquids containing the scent. By incorporating an air based scent sampling device into a retail display that eliminates sample spraying and package tampering, more products may be sampled in a shorter amount of time thereby increasing sales and reducing the cost of product sampling.

### BRIEF DESCRIPTION OF THE FIGURES

FIG. 1 is a cross-section side view of a scent sampling container of the present invention showing air moving inside the container cavity and exiting from a hole in the container wall.

FIG. 2 is a side view of a scent sampling container of the present invention showing air exiting from a hole in the container wall.

FIG. 3 is a cross-section side view a scent sampling container of the present invention showing air moving around inside the container cavity and entering from a hole in the container wall.

FIG. 4 is a cross-section side view of a scent sampling container of the present invention showing air moving around inside the container cavity and exiting from a hole in the container wall. It also shows air simultaneously entering the container from a one-way valve in the wall of the container.

FIG. 5 is a cross-section side view of a squeezable bottle scent sampling container of the present invention showing air moving around inside the container cavity and exiting from an opening in the squeezable bottle.

FIG. 6 is a cross-section side view of a pump spray bottle scent sampling container of the present invention showing air moving around inside the container cavity and exiting from the stem and nozzle in the pump spray bottle.

FIG. 7 is a cross-section side view of a squeezable tube scent sampling container of the present invention showing air moving around inside the container cavity and exiting from the from an opening in the squeezable tube.

FIG. 8 is a side view of a scent sampling container of the present invention being squeezed in a person's hand to expel the scent-laden air from an opening in the wall of the container.

FIG. 9 is a side view of a scent sampling container of the present invention as a person's hand releases pressure on the sides of the container allowing air to re-enter the container through an opening in the wall of the container.

FIG. 10 is a side view of a squeezable bottle scent sampling container of the present invention being squeezed in a person's hand to expel the scent-laden air from the opening in the wall of the container.

FIG. 11 is a side view of a person's finger pressing down a pump spray bottle scent sampling container nozzle of the present invention to expel the scent-laden air from the nozzle in the wall of the container.

FIG. 12 is a cross-section side view of a scent sampling container of the present invention showing air moving around inside the container cavity and exiting from a hole in the container wall. It also shows a tear-away tab that prevents air from entering the container until it is torn off to expose an opening in the container wall.

FIG. 13 is a side view of the scent sampling container of the present invention showing a reclosable tab that can cover an opening in the container to minimize escape of scent-laden air from the container when it is not in use.

FIG. 14 is a side view of a scent sampling container of the present invention that has been inserted into a graphic sleeve.

FIG. 15 is a side view of a scent sampling container of the present invention being inserted into an envelope as part of a direct mail program.

FIG. 16 is a cross-section side view of a polybag, that typically holds a newspaper or catalog, into which a scent sampling container of the present invention has been inserted.

FIG. 17 is a perspective front view of a scent sampling container of the present invention being used as a magazine insert.

FIG. 18 is a perspective front view of a scent sampling container of the present invention being inserted into a shopping bag.

FIG. 19 is a side view of a scent sampling retail display of the present invention used on a retail shelf.

FIG. 20 is a side view of a scent sampling retail display of the present invention used on a retail shelf showing a scent packet tethered to the display, being used by a consumer.

FIG. 21 is a front view of a scent sampling retail display of the present invention used on a retail shelf

FIG. 22 is a side view of a scent sampling retail display of the present invention used on a retail counter or shelf and a quantity of the featured product showing how a tethered scent packet can extend from the display.

FIG. 23 is a perspective front view of a scent sampling display of the present invention with a flexible arm or bridge to hold the scent packet to the display.

FIG. 24 is a front view of a portable scent sampling retail display of the present invention showing how it can be carried around and used in a retail environment as a scent demonstration tool.

FIG. 25 is a cross-section side view of the inside of a scent sampling container of the present invention showing an application of scent oil to the inside walls of the container during production and prior to sealing.

FIG. 26 is a perspective side view of a scent sampling container of the present invention during the sealing process.

FIG. 27 is a side view of an automated production line showing scent oil drops being added to an unsealed scent sampling container of the present invention and the subsequent sealing of the scent sampling container after scent oil has been introduced into the cavity of the container.

FIG. 28 is a side view of an automated production line showing scent oil being added as a spray to an unsealed scent sampling container of the present invention and the subsequent sealing of the scent sampling container being after scent oil has been introduced into the cavity of the container.

FIG. 29 is a cross-section side view of a scent sampling container of the present invention showing the introduction of scent oil after assembly.

### DETAILED DESCRIPTION OF THE INVENTION

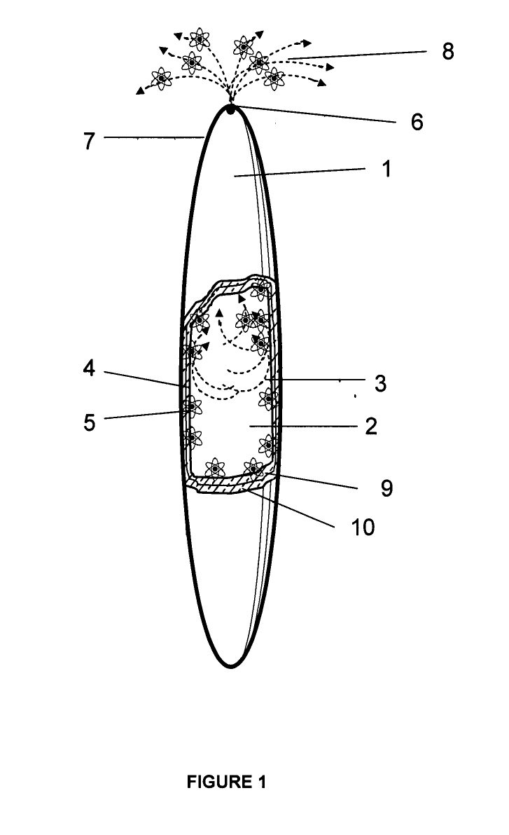

FIG. 1 is a cross-section side view of scent sampling container 1 showing air 3 circulating inside the container cavity 2 and coming in contact with inside walls 4 of the container 1 where it picks up molecules of the scented oil 5 that has coated inside walls 4 of the container. The air then moves toward opening 6 in container outside wall 7 when pressure is applied to the outside wall 7 of the container. As air 8 exits from the container it may be experienced by a person who is using the container as a scent sampling vehicle. This figure also shows inside layer 9 and outside layer 10 of container 1.

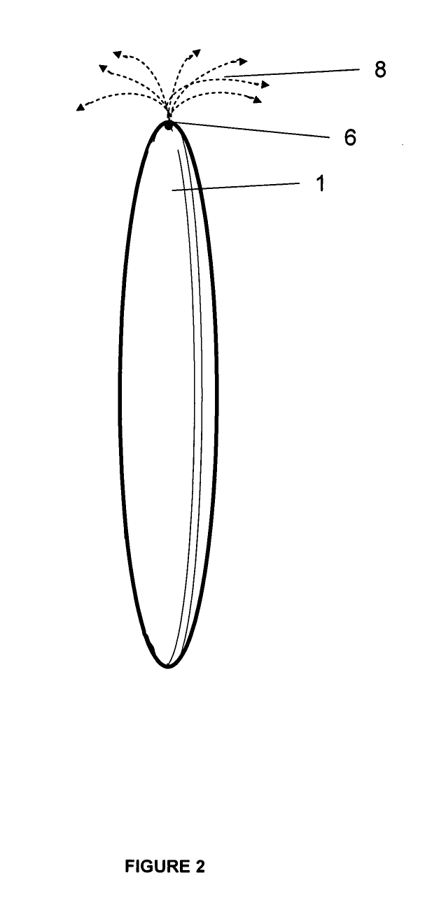

FIG. 2 is a side view of a scent sampling container 1 showing air 8 exiting from opening 6 in the container wall.

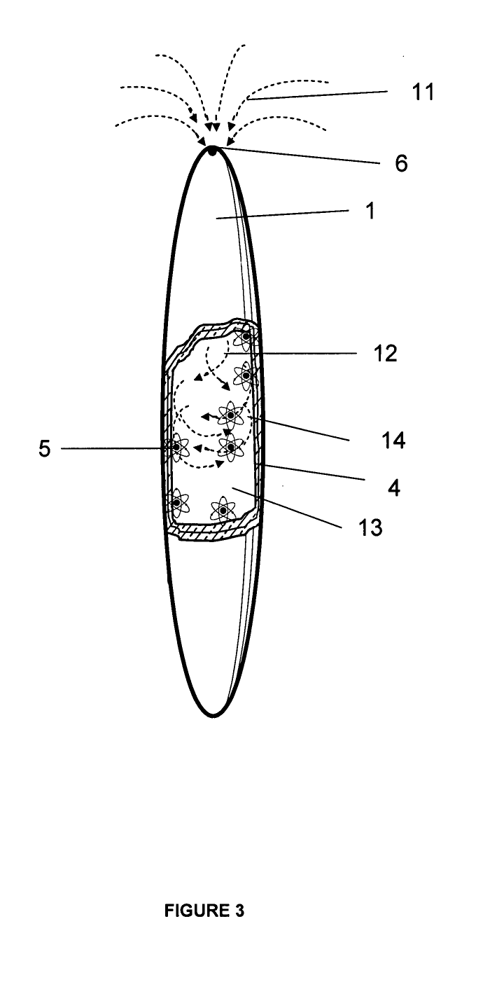

FIG. 3 is a cross-section side view of a scent sampling container 1 showing air 11 entering the container through an opening 6 in the container when pressure is released from the outside walls of the container. As air 12 moves toward cavity 13 of the container 1 it comes in contact 14 with the inside walls 4 of the container thereby picking up scent molecules 5 from the inside wall.

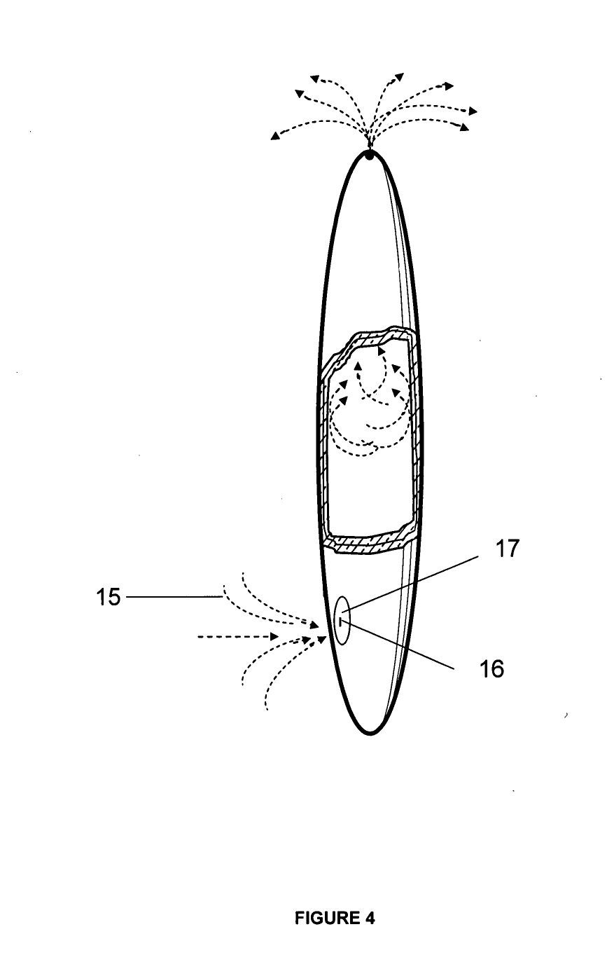

FIG. 4 is a cross-section side view of a scent sampling container from FIG. 1. showing air circulating inside the container cavity and exiting from a hole in the container wall. It also shows air 15 simultaneously entering the container from a one-way valve 16 in the wall 17 of the container.

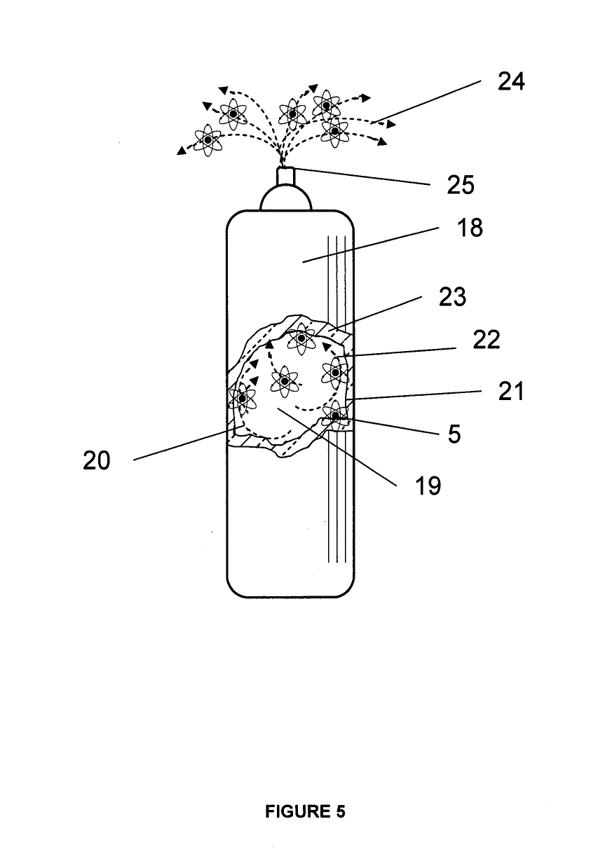

FIG. 5 is a cross-section side view of a squeezable bottle scent sampling container showing air 20 circulating inside container cavity 19 as it picks up scent molecules 5 from inside edge 21 of inner layer 23 of the container. As pressure is applied to the outside walls of the container 18 air 22 moves towards opening 25 in the container. As air 24 exits the container, it can be experienced by a person who is using the container as a scent sampling vehicle.

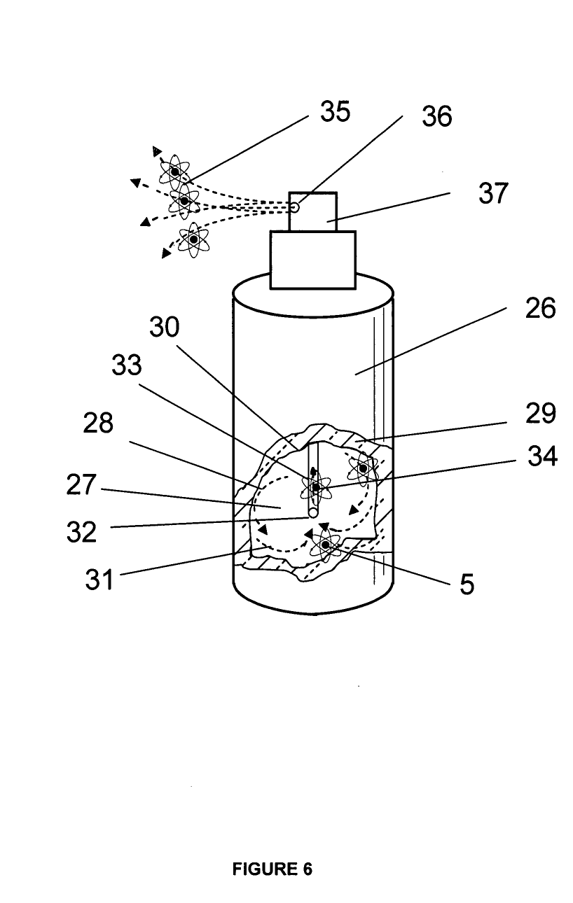

FIG. 6 is a cross-section side view of a pump spray bottle scent sampling container 26 showing air 28 circulating inside the container cavity 27 where it picks up molecules of scented oil 5 that has coated the inside edge 30 of the walls 29 of the container. Air 31 then moves upward 34 toward opening 32 in stem 33 of the pump spray mechanism 37 of the container and exits 35 from the container through nozzle 36 when pressure is applied to the top of the pump spray mechanism 37 where it may be experienced by a person who is using the container as a scent sampling vehicle.

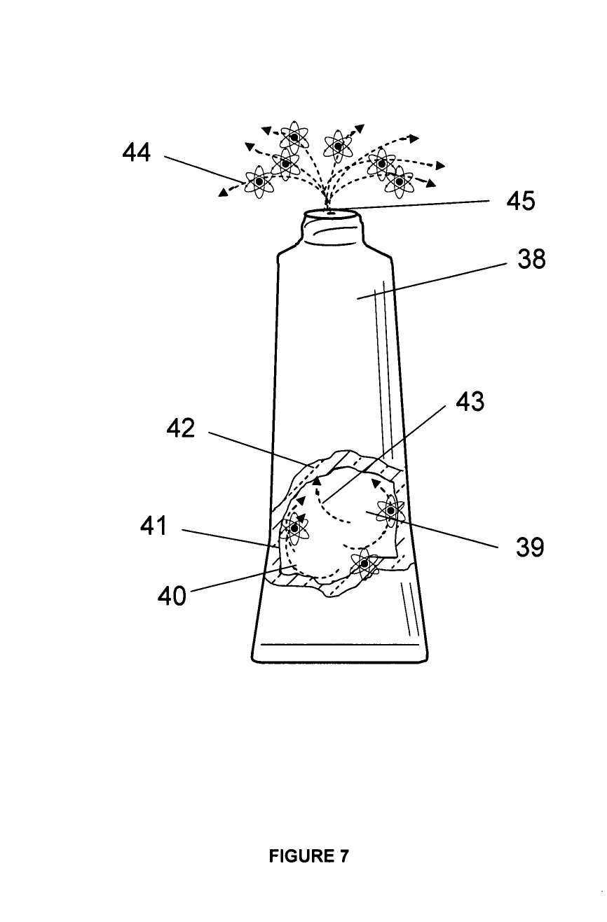

FIG. 7 is a cross-section side view of a squeezable tube scent sampling container 38 showing air 40 circulating inside the container cavity 39 as it picks up scent molecules 5 from the inside edge 41 of container wall 42. As pressure is applied to the walls of the container air 43 moves towards opening 45 in the container and exits 44 the container at opening 45 where it may be experienced by a person who is using the container as a scent sampling vehicle.

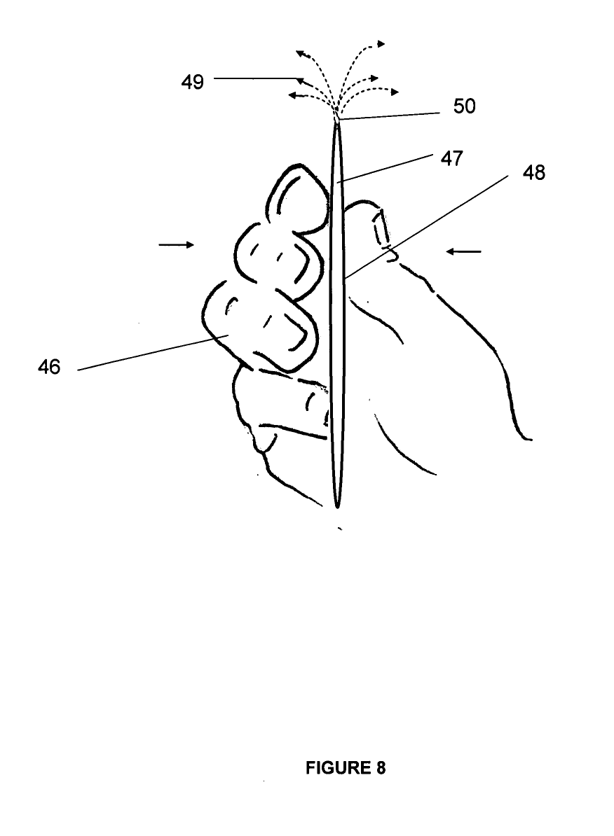

FIG. 8 is a side view of a scent sampling container 47 being squeezed in a person's hand 46 to expel scent-laden air 49 from opening 50 container wall 48.

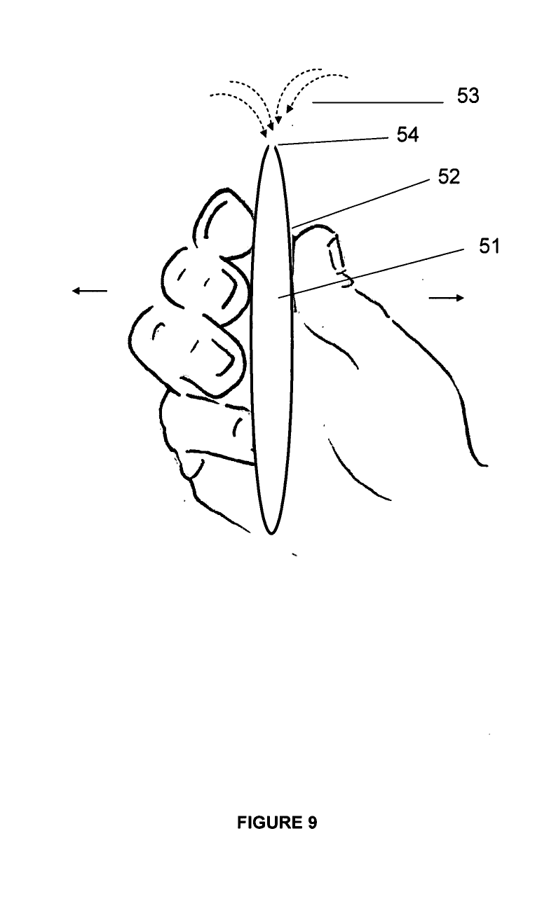

FIG. 9 is a side view of a scent sampling container as a person's hand releases pressure on container sides 52 allowing air 53 to re-enter the container through opening 54 in container 51.

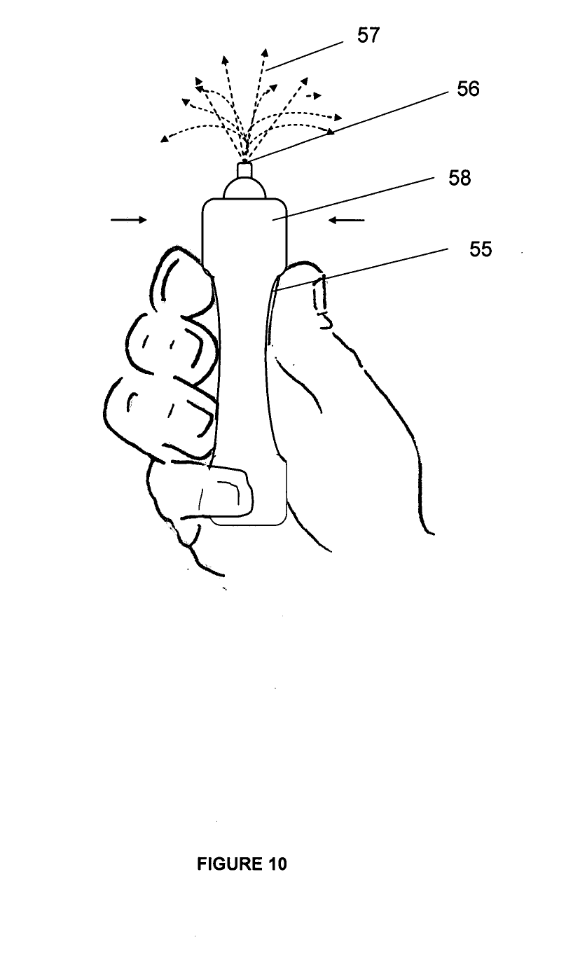

FIG. 10 is a side view of a squeezable bottle scent sampling container 58 with outer wall 55 being squeezed in a person's hand to expel scent-laden air 57 from nozzle 56 container outer wall 55.

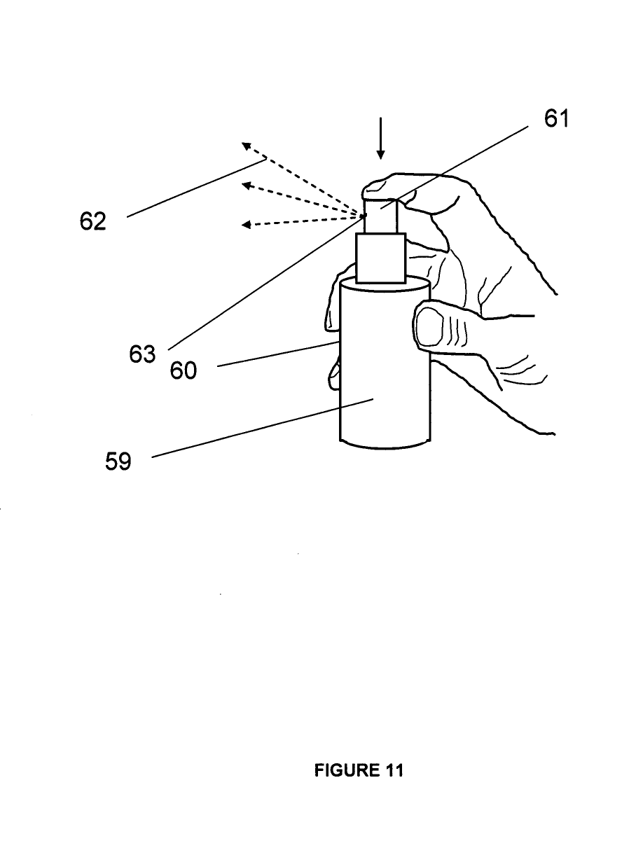

FIG. 11 is a side view of a person's finger pressing down nozzle 61 of a pump spray bottle scent sampling container 59 with an outer wall 60 to expel scent-laden air 62 from opening 63 nozzle 61.

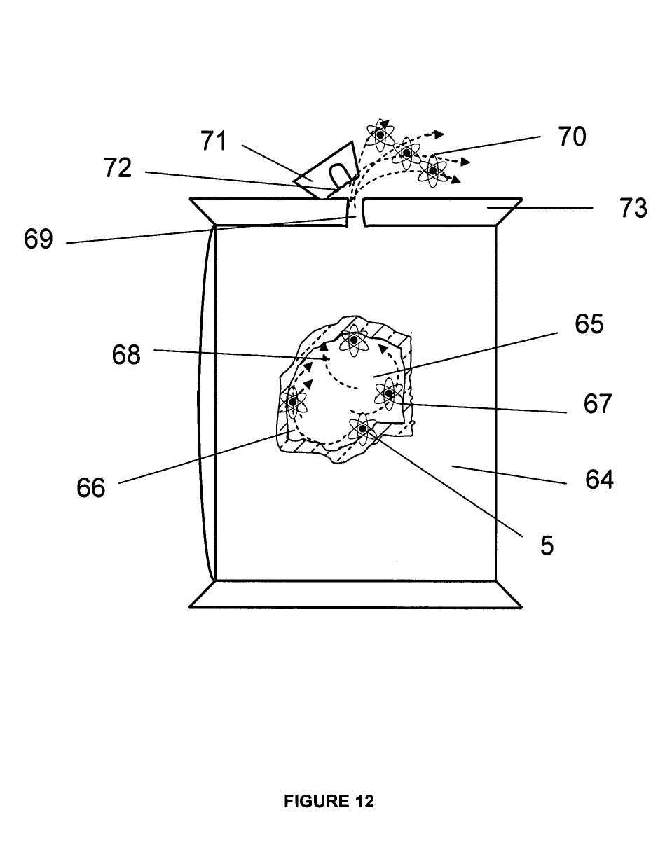

FIG. 12 is a cross-section side view of a scent sampling container 64 showing air 66 circulating inside container cavity 65 and picking up molecules of the scented oil 5 that has coated the inside wall 67 of the container. Pressure on the outer walls of the container 64. causes this scent-laden air to move 68 toward opening 69 in the container. As this air exits 70, it may be experienced by a person who is using the container as a scent sampling vehicle. It also shows a tear-away tab 71 that prevents air from entering the container until it is torn off from perforation 72 in seal 73.

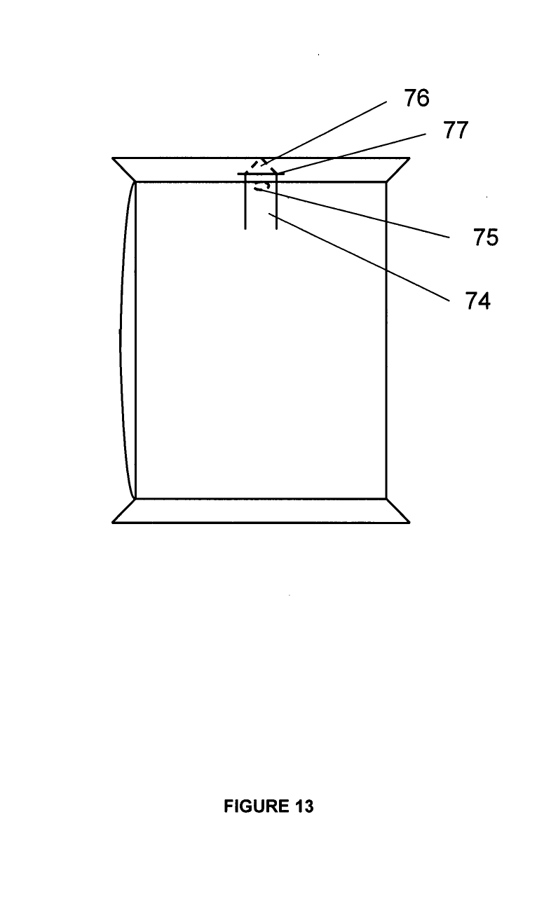

FIG. 13 is a side view of a scent sampling container showing a recloseable tab 74 that can cover opening 75 to minimize escape of scent-laden air from the container when it is not in use. The end 76 of the tab 74 is shown inserted into slot 77 in its closed state.

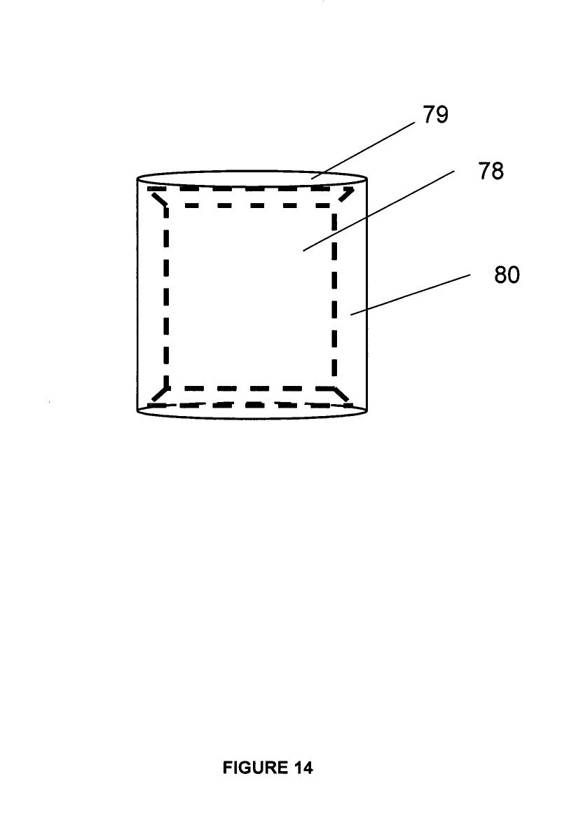

FIG. 14 is a side view of a scent sampling container 78 that has been inserted into a graphic sleeve 80 through an opening in one end of sleeve 79.

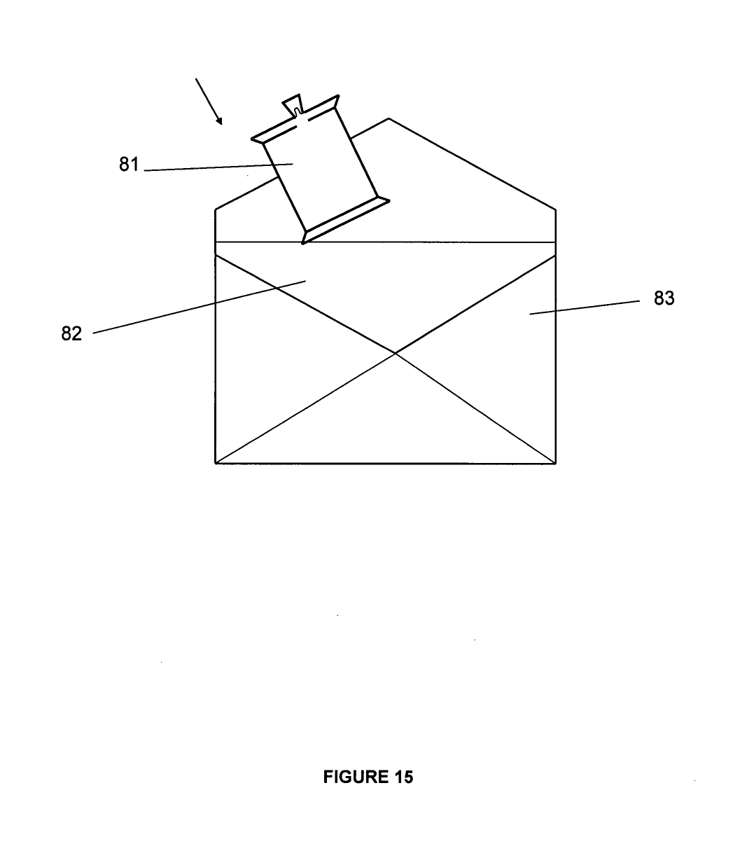

FIG. 15 is a side view of a scent sampling container 81 being inserted into the unsealed end 82 of envelope 83 as part of a direct mail program.

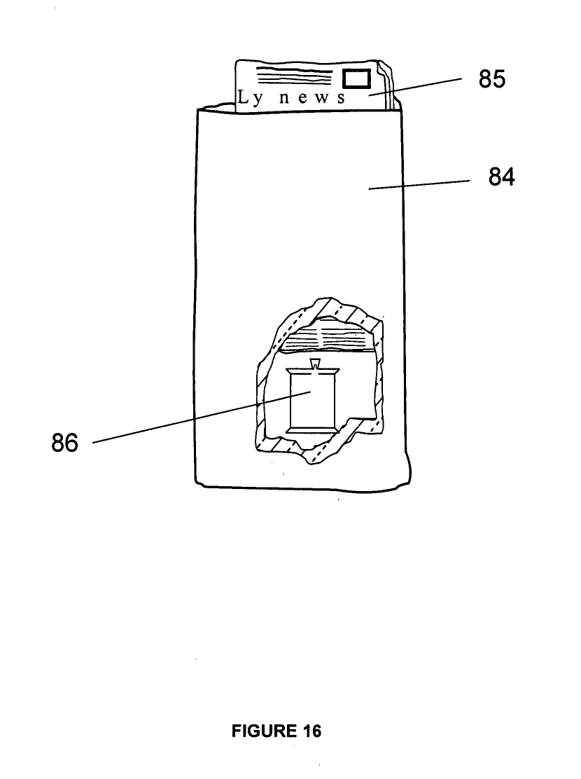

FIG. 16 is a cross-section side view of a polybag 84 that typically holds a newspaper or catalog 85 into which a scent sampling container 86 has been inserted.

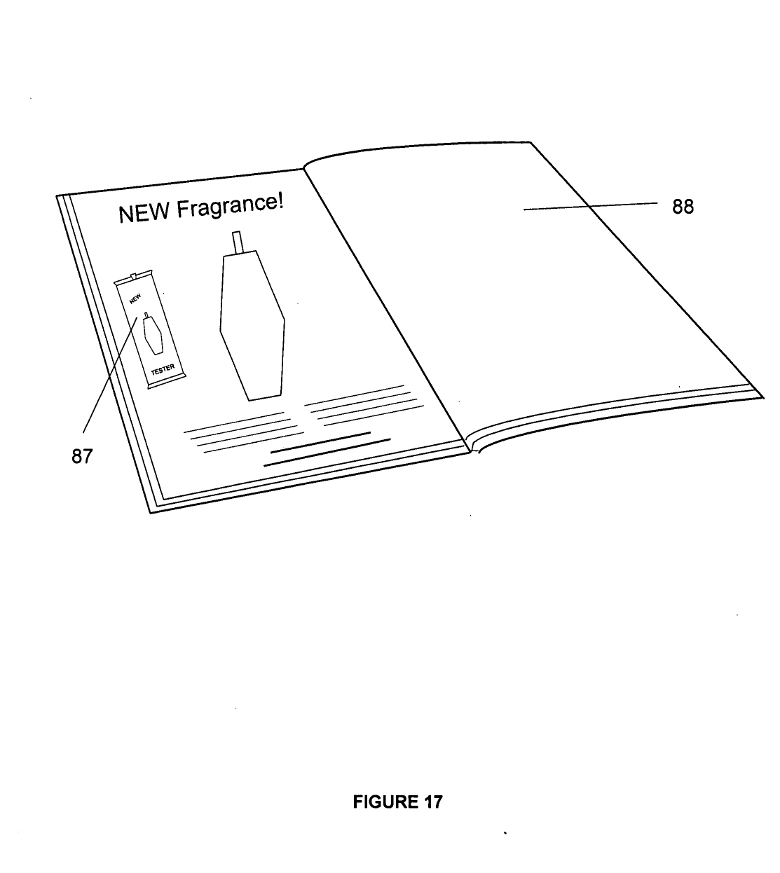

FIG. 17 is a perspective front view of a scent sampling container 87 affixed as an insert into magazine 88.

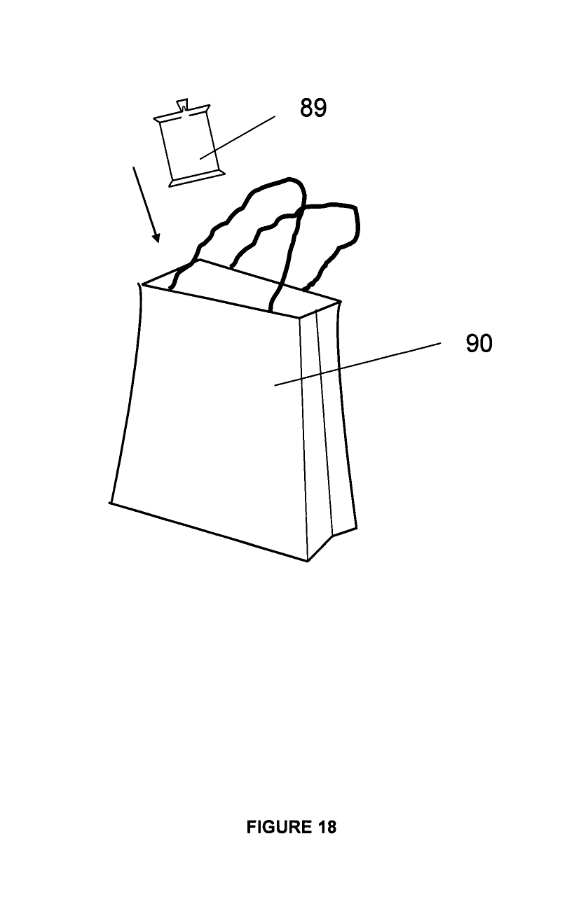

FIG. 18 is a perspective front view of a scent sampling container 89 inserted into shopping bag 90.

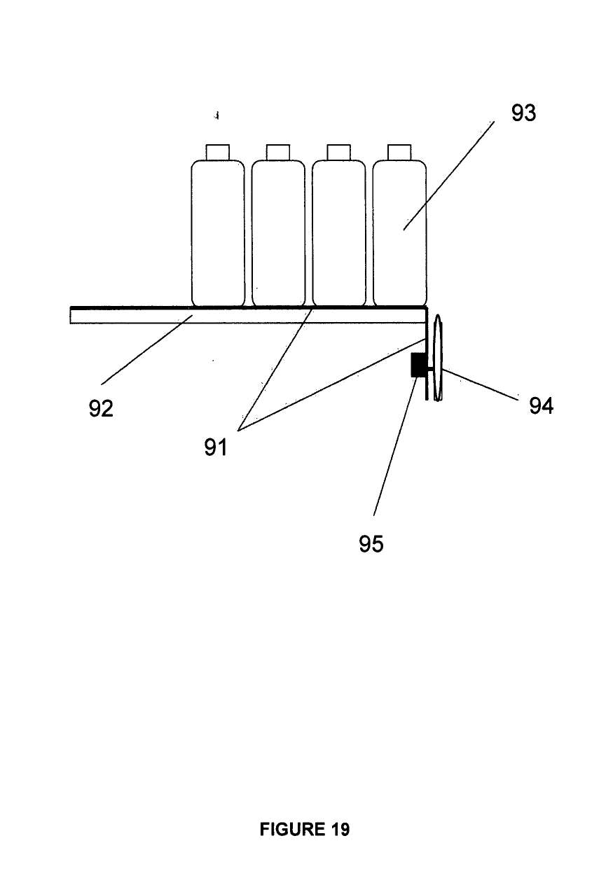

FIG. 19 is a side view of a scent sampling retail display used on retail shelf 92. The display fixture 91 affixes to the shelf and holds the scent sampling container 94. in place so that shoppers can use it to test the fragrance or scent of a displayed product 93. A retractable cord housing 95 is attached to the display to allow the scent container 94 to be affixed to a retractable cord or other tethering device.

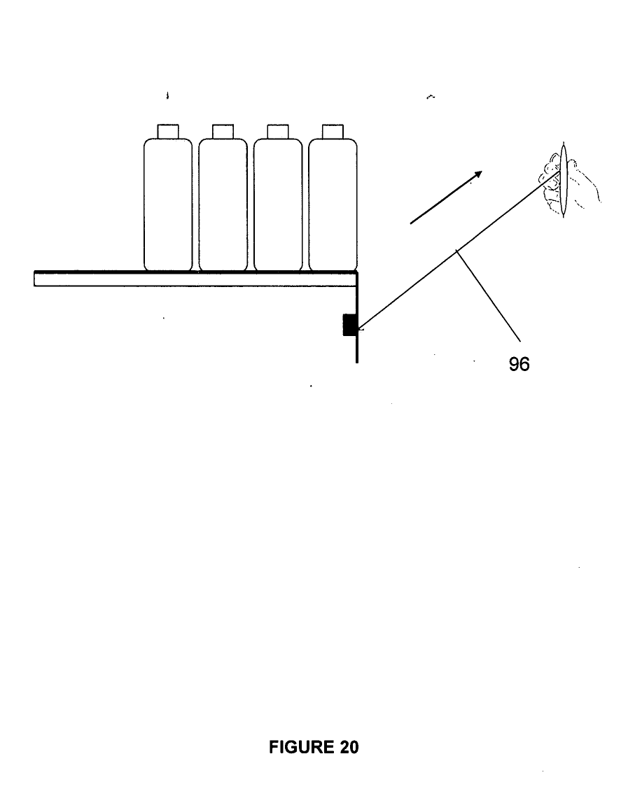

FIG. 20 is a side view of a scent sampling retail display used on a retail shelf showing a scent packet tethered to the display, being used by a consumer. The scent packet is attached to the display with a tether 96 made of string, cord wire or plastic or other material that prevents the scent packet from being removed from the display by a shopper.

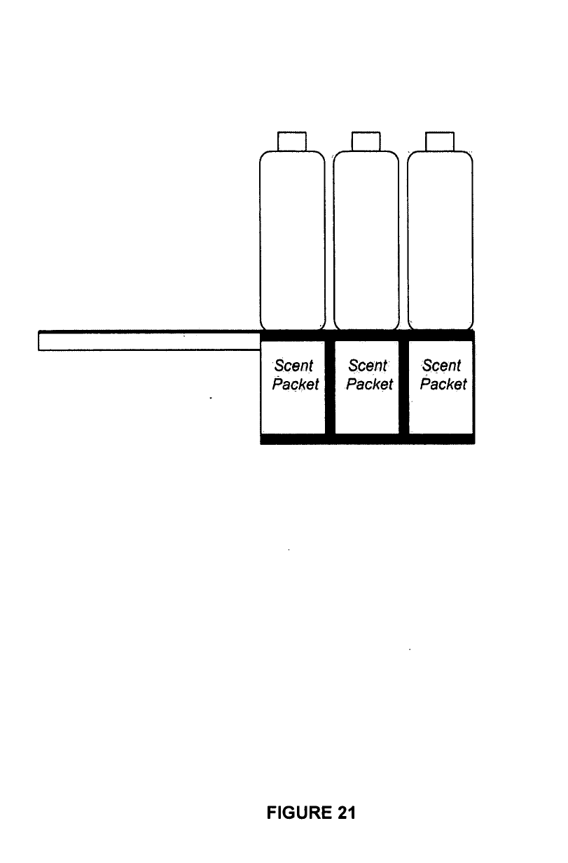

FIG. 21 is a front view of a scent sampling retail display used on a retail shelf.

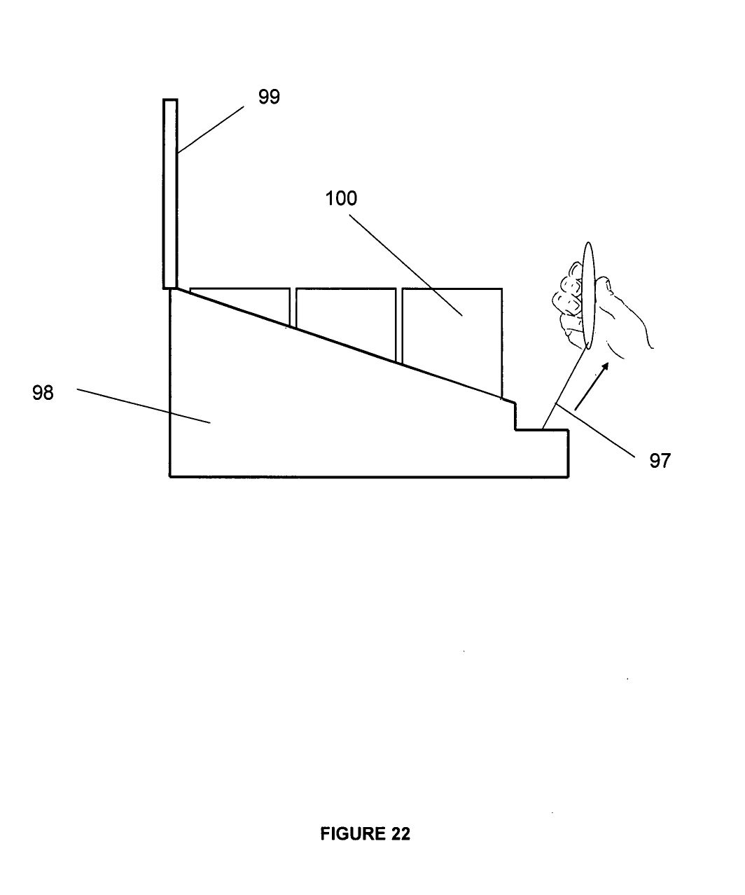

FIG. 22 is a side view of a scent sampling retail display 98 with sign 99 promoting featured product 100 and a scent sampling container that is tethered 97 to the display 98.

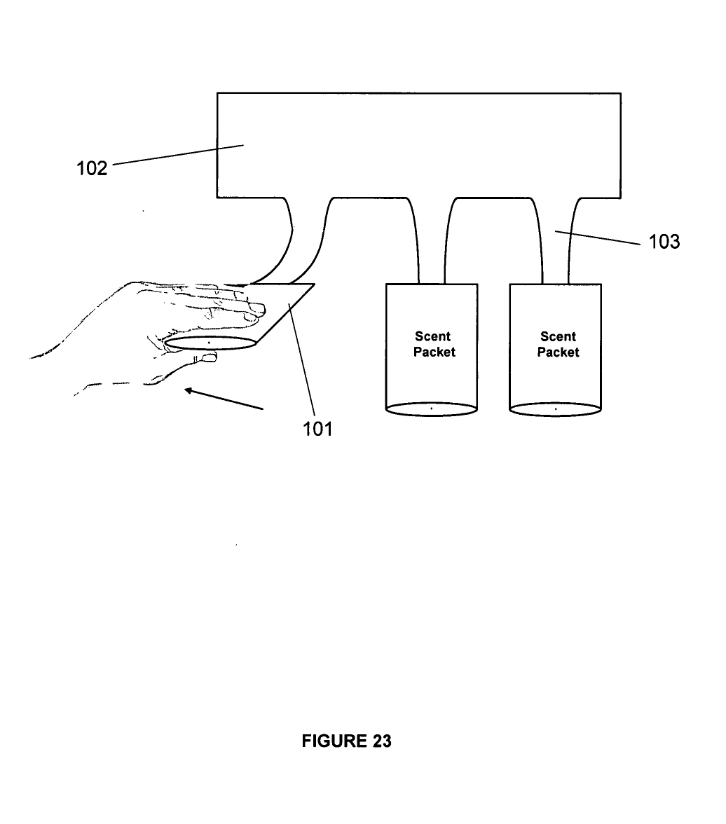

FIG. 23 is a perspective front view of a scent sampling display 102 with a flexible arm or bridge 103 to hold the scent sampling container 101 to the display. A consumer is depicted pulling the scent sampling container upwards to experience the featured scent in the scent packet.

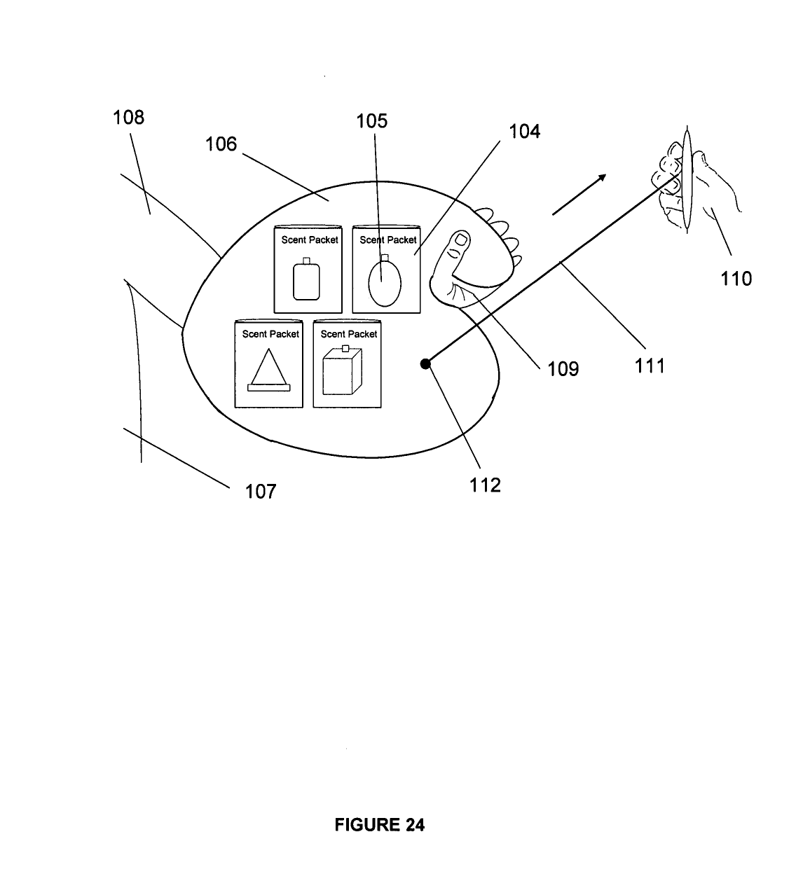

FIG. 24 is a front view of a portable scent sampling retail display 106. showing how it can be carried around and used in a retail environment by a sales associate or fragrance product demonstrator 107. The portable display can rest between a person's shoulder 108 and hand 109. The retractable cord attachment 112 allows the scent sampling container 104 to be affixed to a retractable cord 111 or other tethering device so that a consumer 110 can test the scent sampling container without removing it from the display. Graphics 105 on the scent sampling container 104 can promote the product fragrance that the scent sampling container is featuring.

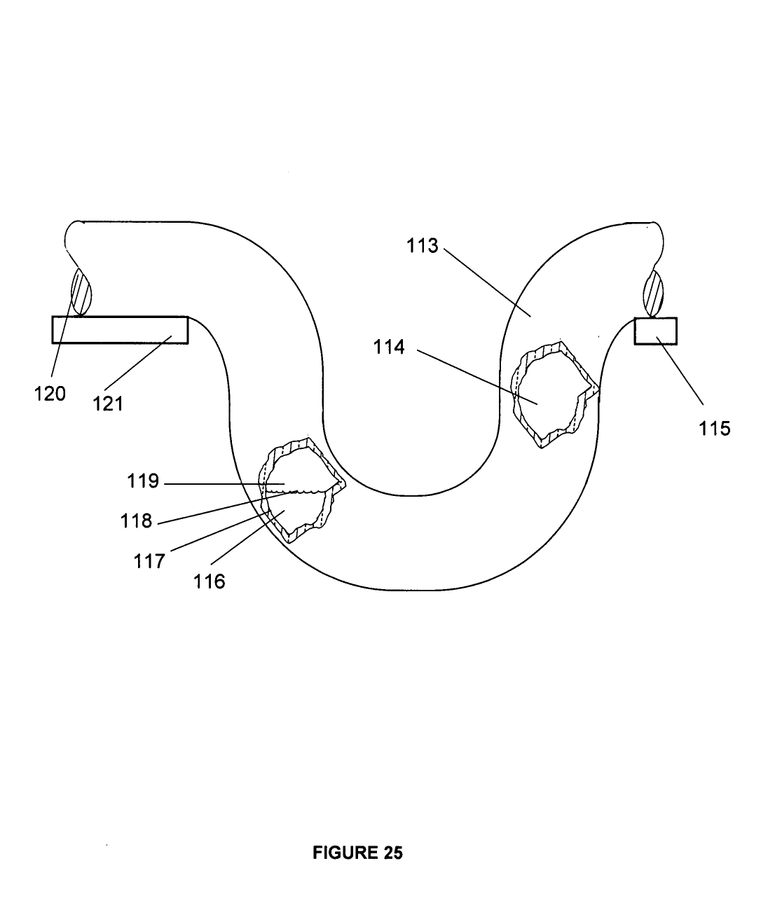

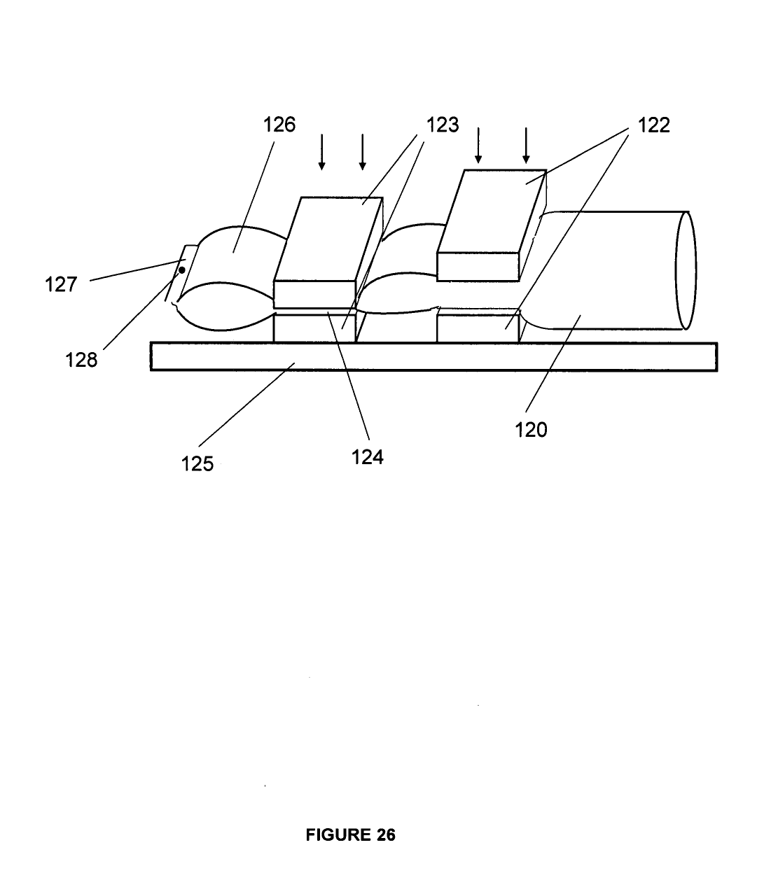

FIG. 25 is a cross-section side view of the inside of a scent sampling container showing an application of the scent oil 116 to the inside walls of the container. The tube 113 made of flexible material rests on table or other flat surface 115. The tube is pulled across a gap so that it bends downward. The inside walls 114 of the tube at this point have not been saturated with scent oil. Scent oil 116 is introduced into the tubing and sits in the low point where the tube bends downward. The scent oil saturates the inside walls 117 of the tube at this point. When the tube is pulled upward, the scent oil level 118 remains stationary. The inside walls of the tube at this point 119 are above the scent oil level and still contain residue from the scent oil that had saturated these walls in the low point of the tube bend. This flexible tube at point 120 is drawn across table 121 prior to being sealed. FIG. 26 is a perspective view of a scent sampling container during the sealing process. It depicts the tube 120 from FIG. 25 resting on the sealing table 125. The sealing arms 122 are compressed onto the flexible tube and when it is compressed completely 123 it seals a section of the tube 124 through heat, radio frequency or other sealing means. The completely sealed scent sampling container 126 now contains air which interacts with the scent-laden interior walls of the packet. Hole 128 is punched or otherwise introduced into the packet into either the walls or the sealed edge 127 of the container from which scent-laden air can escape when the container is squeezed.

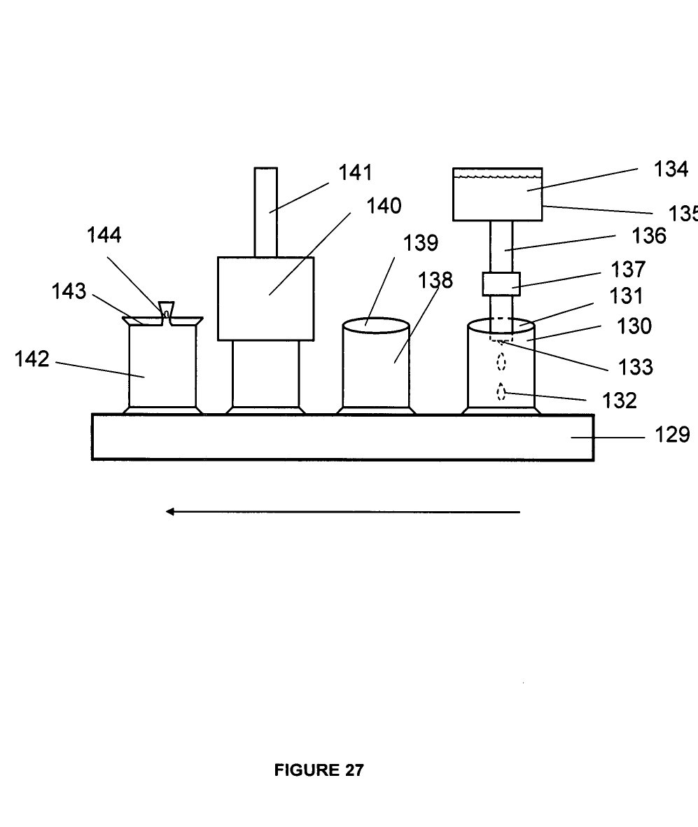

FIG. 27 is a side view of an automated production line showing scent oil drops 132 being added to the unsealed end 131 of a scent sampling container 130. The drops are added to the scent sampling container from a nozzle 133 connected to a fill line 136 and controlled by regulator 137. Tank 135 holds scent oil 134 and feeds it by gravity to the filling line 129. A scent sampling container 138 into which scent oil drops have been introduced with an unsealed end 139 is shown as it proceeds to the sealing area of the production line. Sealing clamps 140 are lowered onto the unsealed scent sampling containers by arm 141. Heat, radio frequency or other means are used to seal the scent sampling container at this point. A sealed scent sampling container 142 can have a tear-away seal 144 in sealed end 143.

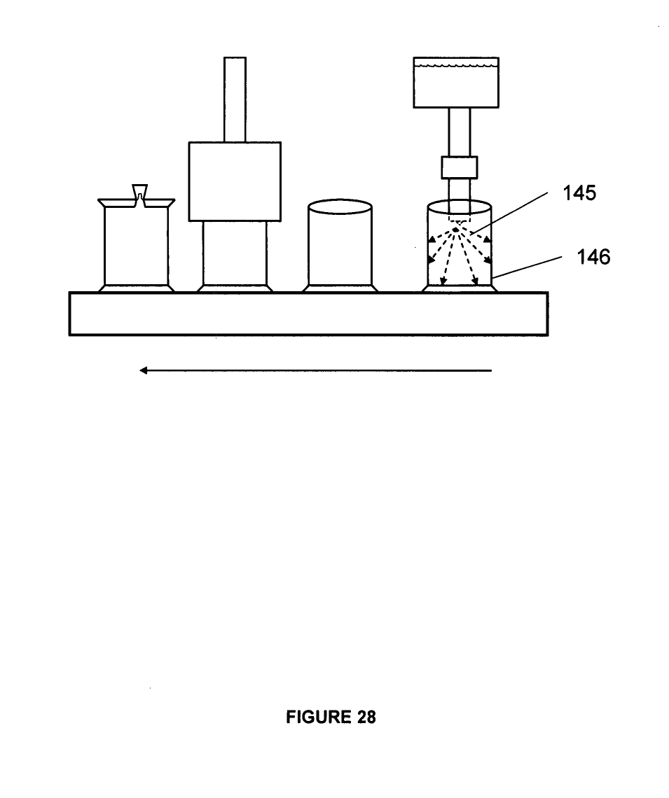

FIG. 28 is a side view of an automated production line similar to that of FIG. 27 showing scent oil being added as a spray 145 to the inside walls 146 of an unsealed scent sampling container and a scent sampling container being sealed after the scent oil has been introduced into the cavity of the container.

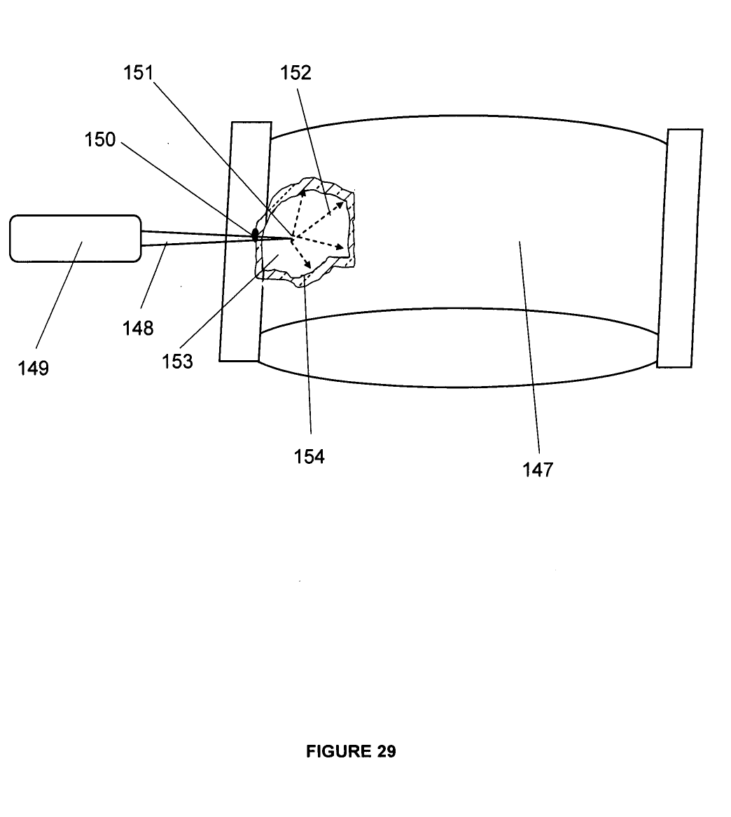

FIG. 29 is a cross-section side view of a scent sampling container showing the introduction of scent oil after assembly. A spray bottle 149 or other container with a neck 14 and nozzle 151 introduces scent oil 152 into the inside cavity 153 through opening 150 in the container walls 147 that had been previously sealed. The inner walls 154 of the scent sampling container absorb the scent oil.

With reference to the embodiments depicted by the foregoing figures, a container wall material of a sampling device of the current invention, according to certain embodiments, allows some molecules of the liquid containing fragrance that is absorbed by the container wall to migrate or evaporate into the air circulating in the cavity inside the container.

A container wall material of a sampling device of the current invention, according to certain embodiments, is capable of holding air inside of the cavity of the container to that when pressure is applied to the container, preferably more than 30 percent of the air will leave the container through an opening for fragrance sampling in the container. In certain other embodiments, a container wall material of a sampling device of the current invention, is capable of holding air inside of the cavity of the container so that when pressure is applied to the container, preferably more than 60 percent of the air will leave the container through an opening for fragrance sampling in the container. In other suitable embodiments, a container wall material of a sampling device of the current invention is capable of holding air inside of the cavity of the container so that when pressure is applied to the container, preferably more than 90 percent of the air will leave the container through an opening for fragrance sampling in the container.

In certain other embodiments, a wall material is capable of maintaining an inner space or cavity in a container of a sampling device of the invention, preferably of sufficient size to hold an amount of air and more preferably of sufficient size to hold an amount of air carrying a sufficient amount of a fragrance to sample said fragrance.

A wall material, in other suitable embodiments, is made of a single layer and in certain other embodiments of more than a single layer. A layer of a wall material, in certain embodiments, is made of a material or mixture of 2, 3, 4, 5, 6, 7, 8 or more materials. A wall material comprising more than a single layer is preferably arranged, in certain embodiments, so that the inner layer or layers are capable of absorbing a fragrance in a liquid and so that one or more outer layers are capable of prohibiting air passage through the wall. An outer layer of a wall made of more than one layer, in certain embodiments, is capable of preventing from 90-100% passage of gas, water, oxygen, moisture, acids, bases and solvents.

Materials suitable for a wall made of a single layer, in certain embodiments, include low density polyethylene (LDPE), high density polyethylene (HDPE), polypropylene, polyethylene terephthalate (PET), polyester, polyvinylidene chloride (PVDC), rubber, ethylene vinyl acetate and polyvinyl chloride with and without plasticizers (PVC). When the wall is made of a single layer of a material that is porous, a selected amount of fragrance carrier, i.e. an amount that will not migrate through the wall's outer surface, may be absorbed on the material's inner surface thereby providing retention thereon. Excess non-absorbed fragrance carrier in an amount that is not emitted from the container when pressure is applied thereto may be retained on the inner surface by surface tension or may settle in the container cavity. When the wall is made of a single layer of a material that is impervious to absorption of the fragrance carrier, a selected amount of fragrance carrier, in an amount that is not emitted from the container when pressure is applied thereto, may be retained on the inner surface of the container by surface tension or may settle in the container cavity.

Materials suitable for a layer, other than the outermost layer, in a wall made of multiple (more than one) layers, in certain embodiments, include cellulose acetate, low density polyethylene (LDPE), high density polyethylene (HDPE), polypropylene, polyethylene terephthalate (PET), polyester, polyvinylidene chloride (PVDC) rubber, ethylene vinyl acetate, and polyvinyl chloride with and without plasticizers (PVC)

Materials suitable for an outermost layer, or any layer not designed to absorb a liquid, in a wall made of multiple layers, in certain embodiments, include styrene, polystyrene, foil laminate, low density polyethylene (LDPE), high density polyethylene (HDPE), polypropylene, polyethylene terephthalate (PET), polyester, polyvinylidene chloride (PVDC), rubber, ethylene vinyl acetate, and polyvinyl chloride with and without plasticizers (PVC)

Materials suitable for a layer designed to prevent passage of air and/or liquid, in a wall made of multiple layers, in certain embodiments, include styrene, polystyrene, foil laminate, low density polyethylene (LDPE), high density polyethylene (HDPE), polypropylene, polyethylene terephthalate (PET), polyester, ethylene vinyl acetate, and polyvinylidene chloride (PVDC).

Materials suitable for a layer designed to maintain a shape of a container with an inner space or cavity, in a wall made of multiple layers, in suitable embodiments, include styrene, polystyrene, low density polyethylene (LDPE), high density polyethylene (HDPE), polypropylene, polyethylene terephthalate (PET), polyester, polyvinylidene chloride (PVDC), rubber, ethylene vinyl acetate, and polyvinyl chloride with and without plasticizers (PVC).

A container wall material of a sampling device of the current invention, according to other suitable embodiments, can accept printing which carry an advertising or promotional message as well as container usage instructions. In other suitable embodiments, the container can be inserted into an outer sleeve onto which messages can be pre-printed.

A container wall material of a sampling device of the current invention, according to suitable embodiments, has a thickness that is between 0.00010 inches thick and 0.1000 inches thick

A container wall material of a sampling device of the current invention, according to certain embodiments, is strong enough to withstand 400 pounds per square inch of pressure. In other suitable embodiments, a container wall material of a sampling device of the current invention, according to certain embodiments, is strong enough to withstand 1000 pounds per square inch of pressure.

A container of a sampling device of the current invention, according to certain embodiments, comprises a wall having dimensions as small as 0.5 inches in length by 0.5 inches wide by 0.0125 inches thick. In other suitable embodiments, the container's dimensions may be as large as 12 inches in length by 12 inches wide by 1.0 inches thick. In certain other embodiments, the container could be any rectangular configuration within the parameters mentioned above.

In other suitable embodiments, the container could have a shape other than a rectangle. In certain other embodiments it could be the shape of a featured scent product such as a perfume bottle shape or a scented candle shape or a scented hand lotion bottle shape.

An opening in a container of a sampling device of the current invention, according to certain embodiments, allows air to escape from or be expelled from the container from inside the container when pressure is applied to the walls of the flexible container, or in the case of a spray pump bottle, when the nozzle in the bottle is pushed down. This air has been scented by coming in contact with the inner walls of the cavity of the container which are imbued with liquid containing fragrance, scent or aroma. In certain embodiments of a sampling device of the current invention, air can escape through one or more openings in a wall or walls of the container. In certain embodiments of a sampling device of the current invention, the opening can be a simple hole. In certain other embodiments of a sampling device of the current invention, the opening can be a valve. In certain embodiments of a sampling device of the current invention the valve can allow air to pass into and out of the container. In certain other embodiments, the opening can only let air escape from the container.

With other suitable embodiments of a sampling device of the current invention, the hole or valve can have an attachment that covers the hole or valve when the container is not in use to diminish evaporation of the scent molecules on the walls of the inside of the container.

An opening in a container of a sampling device of the current invention, according to certain embodiments, allows air to enter the container from outside the container when the air pressure inside the container is less than the air pressure outside the container. This occurs when the outside walls of the container are no longer being squeezed or in the case of a spray bottle, after pressure on the spray nozzle has been released. The walls rebound to their original shape, or in the case of the spray bottle a mechanism in the stem of the nozzle rises up in the stem. When this occurs, the air pressure inside the cavity, or in the case of a spray bottle, the air pressure in the stem, is less than the outside air pressure. Air rushes into the container to equalize this pressure difference. In certain embodiments of a sampling device of the current invention, air can enter through one or more openings in a wall or walls of the container. In certain embodiments of a sampling device of the current invention, there is one opening. In certain other embodiments of a sampling device of the current invention, there can be more than one opening. In certain embodiments of a sampling device of the current invention, the opening can be a simple hole. In certain other embodiments of a sampling device of the current invention, the opening can be a valve. In certain embodiments of a sampling device of the current invention the valve can allow air to pass into and out of the container. In certain other embodiments, the opening can only let air into the container through a one-way valve. With other suitable embodiments of the present invention, the valve may have properties of a one-way evacuated tube stopper as described in U.S. Pat. No. 4,134,512. In certain other embodiments of a container of a sampling device of the current invention, the valve can have properties of the valve typically used in a bag of freshly roasted coffee. This valve built into the walls of the bag holding coffee beans lets gas out of the bag but does not let in air to maintain freshness.

A fragrance, scent or aroma that can be used in a sampling device of the current invention, according to certain embodiments, may be natural. In certain other embodiments, the fragrance, scent or aroma that can be used in a sampling device of the current invention may be artificial. The natural and artificial fragrances, scents and aromas may be used in a sampling device of the current invention, according to certain embodiments, to promote or remind consumers of certain products. These products include but are not limited to: perfumes, colognes, eau de perfumes, eau de colognes, eau de toilettes, personal care products such as deodorants, toothpastes, soaps and shampoos, household products such as detergents, fabric softeners and air fresheners, food and beverage products such as chocolate, coffee, buttered popcorn, candy, and gum.

A substance that can be used in a sampling device of the current invention, according to certain embodiments, can carry a fragrance, scent or aroma and so that the inner walls of the container will adsorb the substance carrying the fragrance, scent or aroma. In certain embodiments of a sampling device of the current invention, the substance may be an oil. Some of the oils that may be used to carry the fragrance, scent or aroma include vegetable oil, olive oil, soy oil, almond oil, fractionated coconut oil (caprylic/capric triglyceride), essential oils, infused oils and other substances with a hydrophobic molecular structure.

In other suitable embodiments of the present invention, the carrier substance may be a hydrosol which is a by-product of the production of essential oils and is lighter than an essential oil. In other suitable embodiments, the substance may be a hydroalcoholic extract in a glycerine solution or a hydroalcoholic extract in an oil. The carrier substance may also be a solvent or diluent such as tripropylene glycol monomethyl ether (TPM) or a substance having a hydrophilic molecular structure which makes it bond well with water.

In other suitable embodiments of the present invention, the carrier substance may be Perfumer's Alcohol that contains SD40B Alcohol, isopropyl myristate and isopropyl alcohol or Formulator's Alcohol that contains SD40B alcohol, propylene glycol and isopropyl alcohol.

Suitable carrier substances may also include ECO-FOAM™ which is extruded foam from American Excelsior, Inc., Arlington, Tex. These materials are substantially dry, rigid, open-celled foams consisting essentially of vegetable starches. Other foams of a different material may also be used as the carrier substanceal.

In certain embodiments of a sampling device of the current invention, fragrances may be used from artificial materials or naturally occurring materials such as flowers, leaves, bark, needles, fruit rind, fruit juice, aromatherapy oils, herbs, and spices. The fragrance scent or aroma may be introduced to a container of the present invention as an essence in its pure, natural and/or extracted form or alternatively may be combined with a carrier substance as described above prior to its introduction into the container. In accordance with the present invention, fragrance carrier that may be introduced into a container shall mean fragrance, scent or aroma as an essence in its pure form and/or the fragrance, scent or aroma in combination with a carrier substance as described above.

A fragrance, scent or aroma of container of a sampling device of the present invention, according to certain embodiments, may be loaded into the container. In certain embodiments of a container of a sampling device of the current invention, the fragrance, scent or aroma may be loaded into the container of a sampling device by introducing a substance carrying the fragrance, scent or aroma into the inner cavity of the container. In certain embodiments of a container of a sampling device of the current invention, the substance carrying the fragrance, scent or aroma may be introduced into the inner cavity of the container of a sampling device so that some or all of it is absorbed by the inside edge of the walls of the inner cavity of the container of a sampling device. When only a portion of the substance carrying the fragrance is absorbed, additional substance, in an amount that will not be emitted from the container when pressure is applied thereto, may be retained by the inside edge of the walls through surface tension or may settle within the container cavity.

A substance carrying a fragrance, scent or aroma into a container of a sampling device of the current invention, according to certain embodiments, may be injected into the inner cavity of an unsealed container of a sampling device with a nozzle connected to a fill line that delivers drops of the substance into the inner cavity of the container. In this case the drops slide down the inside edge of the walls of the inner cavity of the container and is absorbed into the walls. According to other suitable embodiments of the present invention, a nozzle connected to a fill line delivers the substance carrying the fragrance, scent or aroma in the form of a spray. In this case the spray coats the inside edge of the walls of the inner cavity of the container and is absorbed into the walls.

In certain other embodiments of the present invention, a nozzle connected to a fill line delivers the substance carrying the fragrance, scent or aroma in the form of a foam. In this case the foam coats the inside edge of the walls of the inner cavity of the container and some of it is absorbed into the walls. Some of the foam would remain inside the container and would continue to act as a scent wick, in similar fashion to the manner in which the inside walls of the container act as a wick.

According to certain embodiments of the present invention, a substance carrying a fragrance, scent or aroma, may be introduced to the inside edge of the inner cavity walls of the container by filling a flexible tube or other embodiment of the container with the substance and then draining the substance out of the inner cavity. In this case, some of the substance carrying the fragrance, scent or aroma is absorbed by the inside edge of the walls of the inner cavity of the container before it is drained off. With other suitable embodiments, the substance carrying the fragrance, scent or aroma may be drained off by gravity or by pressure.

According to certain embodiments of the present invention, a substance carrying a fragrance, scent or aroma, may be introduced to the inside edge of the inner cavity walls during the production of the container using thermoplastic production. In this process the substance carrying the fragrance, scent or aroma is added to the other elements of a plastic production process during the heat molding phase. After the material cools, the fragrance, scent or aroma that has been encapsulated in the plastic type material continues to migrate or escape into the surrounding air and can be experienced by people using the container.

According to certain embodiments of the present invention, a fragrance, scent or aroma may be loaded into a container that had previously been sealed, either with or without the presence of fragrance during the initial assembly and sealing of the container. The substance carrying the fragrance, scent or aroma may be loaded into the inner cavity of the previously sealed container of a sampling device so that some or all of it is absorbed by the inside edge of the walls of the inner cavity. Additionally, the substance carrying the fragrance, scent or aroma that is loaded may or may not match the fragrance that was present at the time the container was initially sealed. For particular requirements, the introduction of a substance carrying fragrance, scent or aroma into a container that did not contain fragrance as a result of the initial assembly and sealing, enables sampling of a relatively small amount of product without the expense and time associated with large automated production level quantities.

According to certain embodiments of the present invention, drops or spray of the substance carrying fragrance, scent or aroma may be loaded into the inner cavity of the previously sealed container by inserting a spray nozzle connected to a bottle or other receptacle into a hole or opening in the previously sealed container. The drops or spray of the substance carrying the fragrance, scent or aroma coat the inside edge of the walls of the inner cavity of the previously sealed container.

In certain embodiments of the present invention, the container may be a flexible container such as a squeeze bottle and the substance carrying a fragrance, scent or aroma may be introduced thereto by unscrewing the cap of the bottle, loading the substance carrying a fragrance, scent or aroma and then replacing the cap of the bottle. The squeeze bottle may also be loaded with substance carrying a fragrance, scent or aroma that has been dropped or sprayed into the inner cavity of the previously sealed container.

In certain embodiments of the present invention, the container may be a flexible container such as a squeeze tube and the substance carrying a fragrance, scent or aroma may be introduced thereto by unscrewing the cap of the tube, loading the substance carrying a fragrance, scent or aroma and then replacing the cap of the tube. The squeeze tube may also be loaded by dropping or spraying the substance carrying a fragrance, scent or aroma into the inner cavity of the previously sealed container.

In certain embodiments of the present invention, the container may be a flexible container such as a spray pump bottle and the substance carrying a fragrance, scent or aroma may be introduced thereto by unscrewing the cap of the bottle, loading or spraying the substance carrying a fragrance, scent or aroma and then replacing the cap of the spray pump bottle.

According to suitable embodiments of the present invention, the substance carrying a fragrance, scent or aroma that has been introduced to flexible containers will recoat the walls of the inner cavity of the previously sealed container and then be absorbed and/or retained by those walls.

A container of the present invention may resemble an envelope having a pillow shape that may be made by extruding plastic and stamping it into individual containers. In a certain embodiments of the present invention, containers may be stamped (sealed) on both ends at the same time or at each end one at a time. When both ends are stamped at the same time, the substance carrying the fragrance, scent, or aroma should be introduced into the container prior to the stamping.

A container of the present invention may be stamped on one end and then run through an automated manufacturing fill line. In this embodiment, the substance carrying the fragrance, scent or aroma may be introduced into the unsealed end of the container with a vertical nozzle just prior to stamping. Suitable embodiments of the present invention also include a tear-away tab stamped into the container wall. This tab can be torn off by the user to allow air to escape the first time the container is squeezed. Alternatively, the container may be made without the tab so there is a pre-formed opening out of which scented air can be squeezed at any time.

A container of the present invention may also be made by a blister pack forming process, a squeeze bottle or spray bottle thermoforming process, a squeeze bottle or spray bottle blow molding process, a squeeze bottle or spray bottle injection molding process or a squeezable tube extrusion process.

According to suitable embodiments of the present invention, scented air from inside a container of a sampling device of the current invention may be forced out of the container. With spray bottles, the scented air may be forced out by pressing down on the spray nozzle which forces the air up through the stem which extends from the nozzle down into the inside cavity of the spray bottle container. Air is forced back into the container after the spray nozzle is released to fill the partial vacuum created by the imbalance in the air pressure inside and outside the container. With squeezable containers, scented air is forced out of the container when squeezed with air forced back into the container after the squeezing ceases to fill the partial vacuum created by the imbalance in the air pressure outside and inside the container.

In suitable embodiments of the present invention, the side walls of the container are made in such a way that they rebound or spring back and do not collapse inward when pressure is applied thereto.

In certain embodiments of a container of a sampling device of the current invention, when air re-enters the container, some of the scent oil molecules that cling to or have been absorbed by the interior walls of the container, migrate to the air inside the container. This process is called wicking or evaporation. In certain embodiments of a container of a sampling device of the current invention, when the container is squeezed again, this scented air escapes from the container through one or more openings or valves. The user can sniff this scented air and experience a fragrance, scent, or aroma.

A container of a sampling device of the current invention in certain embodiments can be combined with other objects to enable it to act as a promotion or sampling vehicle in retail establishments. In certain embodiments a container of a sampling device of the current invention, can be attached or tethered to a display that sits on a shelf, on an end-aisle, on a counter, or a free standing floor display.

In certain embodiments, it can be attached near the product for which it samples the fragrance, scent or aroma. In certain embodiments of a container of a sampling device of the current invention, a tethering device can be used to attach it to a display. These tethering devices include but are not limited to, a string, a coiled cord, an automatic retractable spring cord, a plastic strip or strip made out of other materials, an elastic band or other tethering devices. These tethering devices allow a shopper to experience the sampling device without removing it from the store.

A container of a sampling device of the current invention in certain embodiments can be attached to a portable rigid board or sign that a retail sales associate or product demonstrator can use when walking around a store and interacting with shoppers. All of these displays can carry one or more sampling devices allowing shoppers to quickly compare the fragrances, scents and aromas of different products.

A container of the present invention may be used to market a fragrance or other scented product in a variety of ways. Suitable embodiments include graphics printed on the container to promote the fragrance or other scented product. Sampling devices of the present invention may also be inserted into an outer sleeve which carries pre-printed graphics that advertise or promote the fragrance or may be inserted in a poly bag or other overwrap of a mailed item such as a product catalog, or in a poly bag or overwrap of a delivered item such as a newspaper or door hanger.

In other suitable embodiments, the sampling device may be dropped into a shopping bag by a sales associate in a retail establishment to promote a fragrance that the shopper has not yet purchased or may be packed along with a product that is to be shipped or included in a direct mail program to shoppers' homes.

In certain other embodiments, the sampling device of the present invention may be offered as a free sample through the internet and other electronic media such as radio and television and printed media such as magazines or newspapers or direct mail.

In certain other embodiments, the sampling device may be glued or inserted into a magazine or onto a direct mail card. When using the foregoing marketing techniques, the air inside the container would need to be substantially evacuated prior to sealing the container so that the container is thin enough to qualify for bulk mailing discounts.

While the present invention has been particularly described with respect to the illustrated embodiments, it will be appreciated that various alterations, modifications and adaptations may be made based upon the present disclosure, and are intended to be within the scope of the present invention. While the invention has been described in connection with what are presently considered to be the most practical and preferred embodiments, it is to be understood that the present invention is not limited in scope by the specific embodiments described herein. Reasonable modifications and variations of that described in the foregoing specification will be apparent to those skilled in the art and shall be construed as within the spirit and scope of the invention which shall be defined by the claims appended hereto and all equivalents thereof.

What is claimed is:

1. A fragrance sampling device comprising:
an inner wall having at least one layer that defines an air cavity, said at least one layer comprised of a material capable of retaining a sufficient amount of fragrance carrier;
an outer wall having at least one layer that is substantially impervious to the fragrance carrier;
at least one opening in said inner wall and said outer wall through which only air containing molecules of fragrance that evaporate from the layer of the inner wall into the air cavity is released to the outside of the device when pressure is applied to the device.

2. The fragrance sampling device of claim 1 further comprising a sufficient amount of fragrance carrier that has been retained by the at least one layer of the inner wall.

3. The fragrance sampling device of either claims 1 or 2 wherein the inner wall comprises at least two layers with at least an innermost layer adjacent to the air cavity comprised of a material capable of retaining the fragrance carrier.

4. The fragrance sampling device of either claims 1 or 2 wherein the outer wall comprises at least two layers with at least the outermost layer comprised of a material that is substantially impervious to the fragrance carrier.

5. The fragrance sampling device of either claims 1 or 2 wherein the inner and outer walls provide for spring back resilience to enable refilling of the air cavity with air from outside the device after pressure is applied and air containing molecules of fragrance is released through said at least one opening through said inner wall and said outer wall.

6. The fragrance sampling device of claim 5 wherein the inner wall layers are comprised of a material selected from the group consisting of cellulose acetate, ethylene vinyl acetate, low density polyethylene, high density polyethylene, polypropylene, polyethylene terephthalate, polyester, polyvinylidene chloride, rubber, polyvinyl chloride, styrene, polystyrene and foil laminate.

7. The fragrance sampling device of claim 5 wherein the outer wall layers are comprised of a material selected from the group consisting of cellulose acetate, ethylene vinyl acetate, low density polyethylene, high density polyethylene, polypropylene, polyethylene terephthalate, polyester, polyvinylidene chloride, rubber, polyvinyl chloride, styrene, polystyrene and foil laminate.

8. The fragrance sampling device of claim 2 wherein the fragrance carrier is a carrier containing fragrance said carrier selected from the group consisting of an oil, solvated oil, hydrosol, spray, and foam.

9. The fragrance sampling device of claim 2 wherein the air cavity is evacuated and each of said at least one opening in said inner wall and outer wall sealed after the sufficient amount of fragrance carrier has been retained by the at least one layer of the inner wall.

10. The fragrance sampling device of claim 9 further comprising print material associated with the fragrance.

11. A fragrance sampling device comprising:
a container wall having an inner surface that defines an air cavity and an outer surface,
said container wall comprised of a material that is capable of retaining a fragrance carrier on its inner surface while preventing migration of the fragrance carrier to the outer surface of the container wall when a sufficient amount of fragrance carrier is introduced to said inner surface of the container wall;
at least one opening in said container wall through which only air containing molecules of fragrance that evaporate from the inner surface of the wall into the air cavity is released to the outside of said container wall when pressure is applied to the device.

12. The fragrance sampling device of claim 11 wherein a sufficient amount of fragrance carrier has been retained by the inner surface of said container wall.

13. The fragrance sampling device of claim 11 wherein the container wall provides for spring back resilience to enable refilling of the air cavity with air from outside the container wall after pressure is applied and air containing molecules of fragrance is released through said at least one opening in said container wall.

14. The fragrance device of claim 13 wherein the container wall material is selected from the group consisting of low density polyethylene, high density polyethylene, polypropylene, polyethylene terephthalate, polyester, polyvinylidene chloride, rubber, ethylene vinyl acetate, and polyvinyl chloride.

15. The fragrance device of claim 11 wherein the fragrance carrier is a carrier containing fragrance said carrier selected from the group consisting of an oil, solvated oil, hydrosol, spray, and foam.

16. The fragrance sampling device of claim 12 wherein the air cavity is evacuated and each of said at least one opening in said container wall sealed after the sufficient amount of fragrance carrier has been absorbed by the inner surface of the container wall.

17. The fragrance sampling device of claim 16 further comprising print material associated with the fragrance.

18. A fragrance sampling point-of-sale display comprising:
a fragrance sampling device comprising a container wall having an inner surface that defines an air cavity and an outer surface;
said container wall comprised of a material that is capable of retaining a fragrance carrier on its inner surface while preventing migration of the fragrance carrier to the outer surface of the container wall when a sufficient amount of fragrance carrier is introduced to said inner surface of the container wall;
a sufficient amount of fragrance carrier retained on the inner surface of the container wall;
at least one opening in said container wall through which only air containing molecules of fragrance that evaporate from the inner surface of the wall into the air cavity is released to the outside of said container wall when pressure is applied to the device;
a point-of-sale display having indicia associated with the fragrance molecules thereon;
wherein said fragrance sampling device is tethered to said point-of-sale display.

19. The fragrance sampling point-of-sale display of claim 18 wherein the container wall of the fragrance sampling device is comprised of at least two layers with an innermost layer comprised of a material that is capable of retaining the fragrance carrier when a sufficient amount of fragrance carrier is introduced to said innermost layer of the container wall.
